(19) United States
(12) Patent Application Publication
(10) Pub. No.: US 2012/0092502 A1
(43) Pub. Date: Apr. 19, 2012

(54) SYSTEMS AND METHODS FOR MONITORING PRESENCE AND MOVEMENT

(75) Inventors: Donald Lee Knasel, Atlanta, GA (US); William Henry Donges, Dunwoody, GA (US)

(73) Assignee: MYSNAPCAM, LLC, Atlanta, GA (US)

(21) Appl. No.: 13/271,672

(22) Filed: Oct. 12, 2011

Related U.S. Application Data
(60) Provisional application No. 61/392,832, filed on Oct. 13, 2010.

(51) Int. Cl. G08B 13/00; H04N 7/18

(52) U.S. Cl. 348/159; 340/565; 348/E07.085

(57) ABSTRACT

Systems and methods for monitoring presence and movement are provided. One or more wave sensors configured to emit sound waves and detect reflections of the emitted sound waves may collect measurements data that is provided to one or more processing components, such as a smart security camera or a home security system. The measurements data may be evaluated in order to determine a location of a monitored subject and to detect changes in the location of the monitored subject. In this regard, movement of the monitored subject may be tracked and utilized to implement a wide variety of control actions, such as the control of security cameras and/or the triggering of alarm events.

### CROSS-REFERENCE TO RELATED APPLICATIONS

This application claims benefit of U.S. Provisional Application No. 61/392,832 filed Oct. 13, 2010, and entitled “Low-Cost Apparatus/System for Detecting Presence and Movement,” the disclosure of which is incorporated by reference herein in its entirety.

### FIELD OF THE INVENTION

Embodiments of the invention relate generally to monitoring systems, such as security systems, and more specifically to monitoring systems that are capable of tracking presence and movement of a subject.

### BACKGROUND OF THE INVENTION

Conventional monitoring systems used in homes and businesses, such as security monitoring, heating, and/or lighting systems, typically infer the presence of a human being by sensing motion, presence of body heat, or movement of a door or window. The imprecise nature of these detection methods often results in false detection or false alarms. Many security needs (including well-being and peace of mind) require additional information to determine if an alarm threshold is met. For example, in theft situations, it is often vital to know if a person is coming in a door or going out the door.

Expensive methods for determining this information have been developed using video image processing to determine presence and movement. Cameras can be monitored by humans or video analytics (i.e., video images processed by a computer or image processing machine). The cost to continually monitor cameras using human operators is very expensive and subject to complacency by the human operator; however, this method is widely used when the potential loss is high, such as in banks, casinos, etc. The use of video analytics typically requires substantial computing resources and has a relatively high percentage of false alarms or false misses. Errors may be reduced as computing power increases. However, while computing power is relatively inexpensive, on-premise computing power typically requires significant maintenance, and offsite computing power is subject to latency and network transport costs. Further, image processing systems typically require extensive calibration during setup to accurately detect alarm conditions or limit the false alarms.

Accordingly, improved systems for determining presence and movement are desirable. Additionally, improved systems for tracking movement of a subject are desirable.

### BRIEF DESCRIPTION OF THE INVENTION

Some or all of the above needs and/or problems may be addressed by certain embodiments of the invention. Embodiments of the invention may include systems and methods for tracking the presence, location, and/or movement of a subject. In one embodiment, a monitoring system may be provided. The monitoring system may include at least one wave sensor and at least one processor. The at least one wave sensor may be configured to emit sound waves and detect reflections of the emitted sound waves. The at least one processor may be configured to: receive measurements data from the at least one wave sensor; identify, based at least in part upon the received measurements data, a location of a subject to be monitored; and track, based at least in part upon the received measurements data, movement of the subject.

According to another embodiment of the invention, there is disclosed a method for tracking the presence location, and/or movement of a subject. Measurements data collected by at least one wave sensor configured to emit sound waves and detect reflections of the emitted sound waves may be received by a monitoring system that includes one or more computer processors. Based at least in part upon the received measurements data, the monitoring system may identify a location of a subject to be monitored. Additionally, based at least in part upon the received measurements data, the monitoring system may track movement of the subject.

According to yet another embodiment of the invention, there is disclosed a method for tracking the presence, location, and/or movement of a subject. Measurements data collected by one or more wave sensors may be received by a security camera that includes one or more processing components. The security camera may evaluate the received measurements data to determine a location of a monitored subject. Additionally, based at least in part upon the measurements data, the security camera may determine a change in location of the monitored subject.

Additional systems, methods, apparatus, features, and aspects are realized through the techniques of various embodiments of the invention. Other embodiments and aspects of the invention are described in detail herein and are considered a part of the claimed invention. Other embodiments and aspects can be understood with reference to the description and the drawings.

### BRIEF DESCRIPTION OF THE DRAWINGS

Having thus described the invention in general terms, reference will now be made to the accompanying drawings, which are not necessarily drawn to scale, and wherein:

FIG. 1 is a schematic block diagram of one example system that may be utilized to detect presence, location, and/or movement of a monitored subject, according to an illustrative embodiment of the invention.

FIG. 2 is a schematic block diagram of an example system that may be utilized to track movement of one or more monitored subjects, according to an illustrative embodiment of the invention.

FIGS. 3A and 3B illustrate example camera configurations that may be utilized in various embodiments of the invention.

FIG. 4 is a block diagram of an example monitoring system that may be utilized to track the movement of a monitored subject, according to an illustrative embodiment of the invention.

FIG. 5 is a block diagram of another example camera that may be utilized in various embodiments of the invention.

FIG. 6 is a flow diagram of an example method for detecting presence, location, and/or movement of a monitored subject, according to an illustrative embodiment of the invention.

### DETAILED DESCRIPTION OF THE INVENTION

Illustrative embodiments of the invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

For purposes of this disclosure, the term “monitoring system” may refer to any suitable system configured to evaluate information associated with a monitored subject. Examples of suitable monitoring systems include, but are not limited to, a camera that includes processing functionality, a local monitoring system (e.g., a local security system, a local energy management system, etc.), and/or a central monitoring system (e.g., a central security system server, etc.). As desired, a monitoring system may evaluate a wide variety of different data, such as measurements data received from any number of wave sensors. Additionally, a monitoring system may direct and/or implement any number of suitable control actions, such as the triggering of an alarm or the control of any number of additional monitoring devices (e.g., cameras, etc.).

Disclosed are systems and methods for determining and tracking the presence, location, and/or movement of a monitored subject. In certain embodiments, one or more wave sensors, such as ultrasonic sensors, may be utilized to monitor a desired area. A wide variety of suitable wave-emitting sensing devices may be used as desired in various embodiments of the invention. The cost and physics of sound emitting devices provide a relatively economical solution for presence and motion detection. As desired, a wide variety of configurations of wave sensors may be utilized. For example, one or more wave sensors may be integrated into or otherwise associated with a security camera (e.g., incorporated into a camera housing, placed in proximity to a camera, etc.). As another example, a plurality of wave sensors may be arranged in a grid or other configuration about a monitored area (e.g., a room, etc.). For example, each sensor in a grid may be positioned at a different angle in order to provide coverage for a desired area. As yet another example, a plurality of wave sensors may be utilized to form a phased array that is positioned within a monitored area (e.g., positioned on a wall, on a ceiling, in a corner, etc.). The wave sensors may be used to determine presence or may be used in conjunction with another sensor or motion detector to determine presence. Once presence is determined, the wave sensors may be monitored to detect location and movement (e.g., changes in position) of an object of interest.

In operation, a wave sensor may emit a wave (e.g., a sound wave, etc.), and the wave sensor may monitor reflections of the wave. For example, the time between the output of a wave and the receipt of a wave reflection may be monitored. Based upon a determined time delay from output until reflection receipt, a distance between the wave sensors and an object that caused the reflection (e.g., a monitored subject, etc.) may be determined. In this regard, a wide variety of enhanced monitoring services may be provided. For example, a monitoring system may determine a location of a monitored subject, and the monitoring system may identify changes in the location of the monitored subject. In this regard, the monitoring system may track the movement of a monitored subject.

As desired, a monitoring system may implement or direct the implementation of a wide variety of control actions based upon tracking the movement of a monitored subject. As one example, the monitoring system may determine that a monitored subject is moving into the viewing area of a security camera, and the monitoring system may activate the security camera. As another example, the monitoring system may adjust the pan and/or tilt of a security camera based upon the movement and/or location of a monitored subject. As yet another example, the monitoring system may determine that a monitored subject is entering or exiting a room, and the monitoring system may implement a wide variety of actions based upon the determination. For example, the monitoring system may identify a security alert, and the monitoring system may generate a suitable alarm action (e.g., triggering an audible alarm, communicating a message to a user or central control system, activating one or more sensors or monitoring devices, contacting authorities, etc.). As another example, the monitoring system may turn off the lights in a room being exited and/or turn on the lights in a room being entered. A wide variety of other control actions may be taken as desired in various embodiments of the invention.

In certain embodiments, the wave sensors may communicate with one or more suitable monitoring systems. As set forth above, a monitoring system may take a wide variety of different forms. For example, a monitoring system may include a smart camera, a local processing unit, and/or one or more remote processing units (e.g., a central monitoring server, etc.). In one example operation, a camera or local processing unit(s) may capture information from the wave sensors and/or may receive measurements data (e.g., timing information, etc.) from the wave sensors. The local processing unit(s) may then evaluate the collected data in order to determine location and/or movement. As desired, a local processing unit may communicate with a central monitoring server or other remote processing unit. Additionally, in certain embodiments, a local processing unit may complete intermediate processing of the information collected from the sensor(s) and may send the information to a central server. The central server may complete data processing and may return control signals back to the local processing unit.

As desired, the local processing unit may be a gateway device, a local computer, a camera, or any other device with adequate processing capability and network connectivity. The local processing unit may coordinate the provision of control information between the sensors and other devices. For example, if sensors (e.g., cameras, wave sensors, other sensors, etc.) are deployed that utilize wireless communication and a battery power source, it may be desirable to operate the sensors in a keep-alive mode to conserve power and prolong battery life. In certain embodiments, the wave sensors may be activated by sensing gross activity or presence of a subject to be monitored. For example, by using a device such as a body heat motion detector or another convenient device/method, the wave sensors may be activated once a subject enters a monitoring area.

A wide variety of suitable algorithms and/or other processes may be utilized to evaluate data received from wave sensors. For example, an algorithm may be established that evaluates measurements data to determine a location or likely location of a monitored subject. Additionally, the algorithm may evaluate changes in measurements data to track movement of the monitored subject and, as desired, identify events (e.g., a subject entering a monitored area, a subject leaving a room, etc.) based upon the tracked movement. As desired in certain embodiments, stored profile information associated with relatively stationary objects within a monitored area, such as furniture, may be accessed. In this regard, received measurements data indicating these objects may be filtered out from an orientation analysis.

Various embodiments of the invention may include one or more special purpose computers, systems, and/or particular machines that facilitate the determination of body orientation and/or position. A special purpose computer or particular machine may include a wide variety of different software modules as desired in various embodiments. As explained in greater detail below, in certain embodiments, these various software components may be utilized to detect or determine presence, location, and/or movement and to trigger a wide variety of suitable alerts and/or other actions based upon the presence, location, and/or movement of a monitored subject.

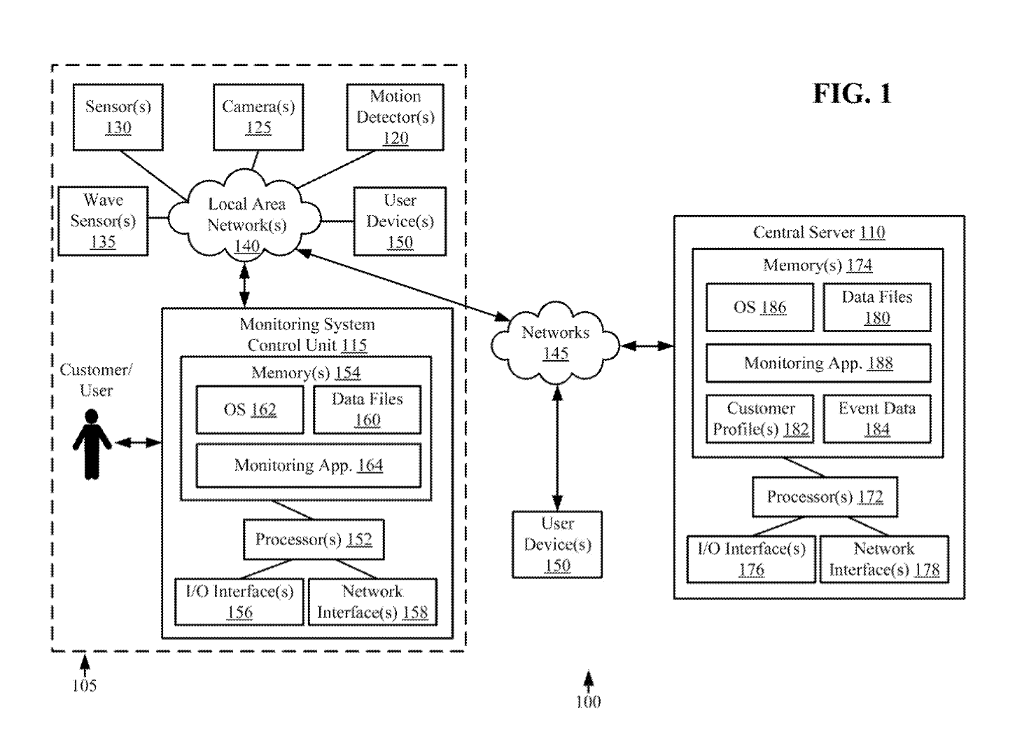

FIG. 1 illustrates one example system 100 that may be utilized to detect presence, location, and/or movement of a monitored subject, according to an illustrative embodiment of the invention. With reference to FIG. 1, the system 100 may include a wide variety of components that are situated within or within relatively close proximity to a structure that is monitored, such as a home, business, or other structure. For example, various system components may be situated within a household 105. Additionally, the system 100 may include a central server 110 configured to receive data, such as sensor data, monitoring data, and/or generated alerts or other communications from devices associated with the household 105.

With reference to the household 105, a monitoring system control unit 115 and/or any number of sensing devices, such as motion detectors 120, cameras 125, and/or other sensors 130 (e.g., microphones or voice detectors, smoke detectors, contact sensors, etc.) may be provided in association with any number of wave sensors 135. As desired, the control unit 115 may communicate with the various sensors via any number of local networks 140 or household networks, such as a local area network, a home area network (“HAN”), a Bluetooth-enabled network, a Wi-Fi network, a wireless network, a suitable wired network, etc. As desired, the control unit 115 may additionally communicate with any number of user devices 150 via the local networks 140, such as a mobile device or other device associated with a user.

Additionally, the control unit 115 and/or any number of the sensors 120, 125, 130, 135 may communicate with any number of external devices, such as the central server 110, via any number of suitable external networks 145, such as a cellular network, a public-switched telephone network, an Advanced Metering Infrastructure (“AMI”) network, the Internet, and/or any other suitable public or private network. As desired, the user devices 150 may also communicate with the central server 110 and/or the monitoring system control unit 115 via the external networks 145.

In certain embodiments, the control unit 115 may be a stand-alone device, such as a monitoring system panel that includes suitable hardware and/or software components. In other embodiments, the control unit 115 may be integrated into one or more of the other illustrated system components 120, 125, 130, 135. For example, the control unit 115 may be integrated into a camera 125. In yet other embodiments, the control unit 115 may be integrated into a wide variety of other devices not illustrated in FIG. 1, such as a utility meter or a home power management system. As desired, the functionality of the control unit 115 may also be distributed among a plurality of different devices.

The control unit 115 may be a suitable processor-driven device that facilitates the management of a monitoring system, such as a household monitoring system. Additionally, in certain embodiments, the control unit 115 may be a suitable processor-driven device that facilitates the evaluation of parameters and/or monitoring data in order to determine presence, position, and/or movement associated with one or more monitored subjects. Examples of suitable devices that may be utilized for and/or associated with the control unit 115 include, but are not limited to, personal computers, microcontrollers, minicomputers, and/or other suitable processor-driven devices. The one or more processors 152 associated with the control unit 115 may be configured to execute computer-readable instructions in order to form a special purpose computer or particular machine that is configured to manage a local monitoring system and/or to facilitate the determination of presence, location (or position), and/or movement associated with one or more monitored subjects.

In addition to having one or more processors 152, the control unit 115 may include one or more memory devices 154, one or more input/output (“I/O”) interfaces 156, and/or one or more network interfaces 158. The memory devices 154 may include any suitable memory devices and/or data storage elements, such as read-only memory devices, random access memory devices, magnetic storage devices, etc. The memory devices 154 may be configured to store a wide variety of information, for example, data files 160 and/or any number of software modules and/or executable instructions that may be executed by the one or more processors 154, such as an operating system (“OS”) 162, and/or a monitoring application 164.

The data files 160 may include any suitable data that facilitates the operation of the control unit 115, such as data that facilitates identification of the one or more sensors 120, 125, 130, 135, data that facilitates communication with the sensors 120, 125, 130, 135, data that facilitates identification of and/or communication with the user devices 150, data that facilitates communication with the central server 110, collected monitoring data, user profile data and/or preferences, and/or profile data associated with one or more monitored areas (e.g., profile data associated with furniture and/or other relatively stationary objects). The OS 162 may be a suitable software module that facilitates the general operation of the control unit 115. Additionally, the OS 162 may facilitate the execution of any number of other software modules, such as the monitoring application 164.

In operation, the control unit 115 may facilitate the management of a local monitoring system, such as a household monitoring system. For example, the control unit 115 may communicate with one or more sensors 120, 125, 130, 135 and/or user devices 150 in order to determine whether certain sensors should be activated and/or whether an alarm event or other event should be triggered. For example, a camera 125 may be activated based upon a determination that a monitored subject has entered a coverage or monitoring area associated with the camera 125. As another example, the pan and/or tilt of a camera may be controlled based upon the determined movement of the monitored subject. As yet another example, an alarm event may be triggered by a security monitoring system based upon the identification of a break-in or unauthorized entry to a monitored area (e.g., detected presence combined with a determination that a monitored subject is entering a monitored area, etc.).

As desired, a monitoring application 164 associated with the control unit 115 and/or a central server 110 in communication with the control unit 115 may facilitate the collection of monitoring data (e.g., measurements data, motion detection data, etc.), the evaluation of monitoring data to detect the presence of a subject to be monitored, and evaluation of monitoring data to detect a location and/or to track movement or motion of the subject, the identification of alarm events and/or other events (e.g., room entering events, room exit events, entering the viewing area of a camera, etc.), and/or the execution of one or more control actions. The monitoring application 164 may be a suitable software module that receives the various inputs from sensors 120, 125, 130, 135 and executes one or more action(s) based at least in part upon the evaluation of the received inputs and/or instructions received from the central server 110.

A wide variety of suitable operations may be performed by the monitoring application 164 as desired in various embodiments of the invention. For example, the monitoring application may identify one or more sensors associated with a monitored area. These sensors may include one or more wave sensors 135. Additionally, the monitoring application 164 may determine a wide variety of profile information associated with the sensors (e.g., a covered area, configuration data, etc.), the monitored area (e.g., positions and/or dimensions of relatively stationary objects, etc.). In certain embodiments, at least a portion of the profile information may be collected during a learning mode and/or configuration mode of the monitoring application 164. For example, wave sensors may be utilized to determine dimensions of one or more objects in a monitored area, and at least a portion of the dimension information (as well as location or position information) may be stored.

In certain embodiments, the monitoring application 164 may activate one or more wave sensors 135 based upon a detected presence of a subject to be monitored. For example, data collected from a suitable motion detector 120 may be evaluated in order to determine the presence of a subject, and the wave sensors 135 may be activated by the monitoring application 164 based at least in part upon the detected presence. Once activated, the wave sensors 135 may take measurements of the monitored area (e.g., timing measurements for wave reflections, etc.), and measurements data may be received and processed by the monitoring application 164. In this regard, the monitoring application 164 may track a subject located within the monitored area. For example, a location of the monitored subject may be determined, and changes in the location may be identified in order to track movement of the subject.

In certain embodiments, a wide variety of control actions may be implemented or directed by the monitoring application 164 based upon determined movement or motion associated with a monitored subject. For example, a determination may be made that a monitored subject is entering the detectable area of a camera 125 (or other sensor), and the camera 125 (or other sensor) may be initiated (i.e., turned on, taken out of a sleep mode or power conservation mode, etc.). As another example, the pan, tilt, and/or other motion of a camera 125 may be controlled based upon the monitored movement of a subject. As another example, a determination may be made that a monitored subject has entered a monitored area, and an alarm condition may be generated. Based upon the alarm condition, a wide variety of additional actions may be taken, including, but are not limited to, the activation of an alarm (e.g., an audible alarm, etc.), the activation of one or more additional sensors and/or monitoring devices (e.g., cameras 125, audio detectors, etc.) that facilitate additional monitoring (e.g., monitoring by security personnel, etc.), the communication of an alert message (e.g., communicating a message to emergency personnel, communicating a message to an individual, communicating a message to monitoring system personnel, etc.), the communication of a message to a user device 150, and/or the escalation of an alert that has not been closed. As yet another example, a determination may be made as to whether a monitored subject is moving from one room or area to another, and a wide variety of actions may be taken based at least in part upon the determination, such as power management actions (e.g., turning lights on and off, etc.), environmental actions (e.g., adjusting air conditioner and heat settings, etc.), etc.

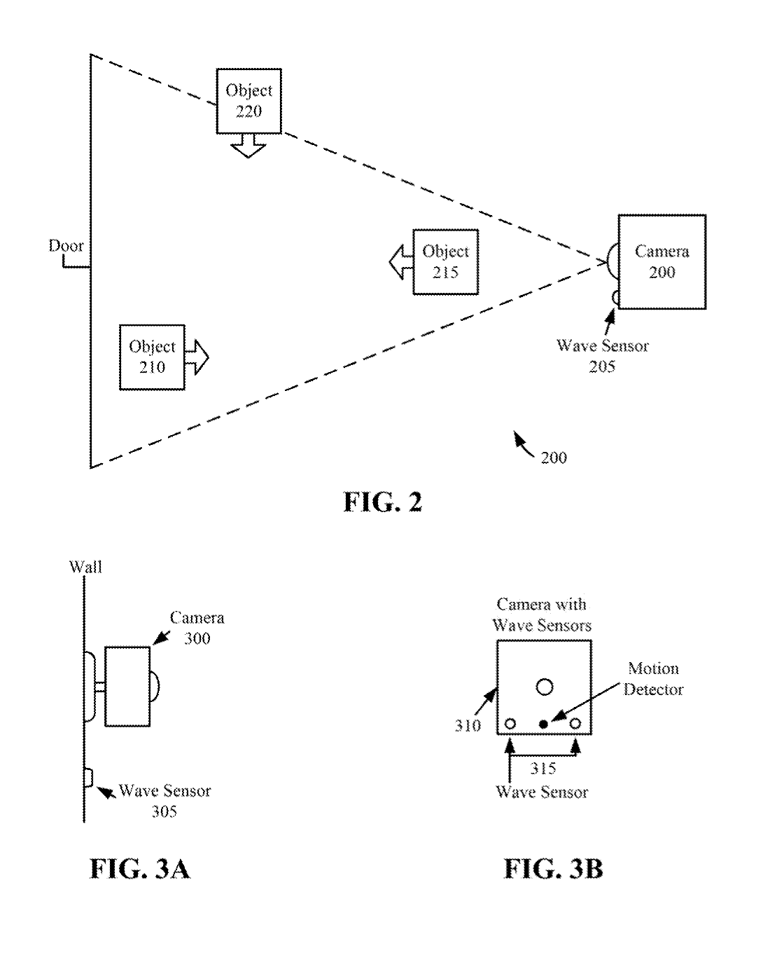

A few examples of the operations that may be performed by the monitoring application 164 are described in greater detail below with reference to FIGS. 2 and 4-6.

With continued reference to the control unit 115, one or more input/output (“I/O”) interfaces 156 may facilitate interaction with any number of I/O devices that facilitate the receipt of user and/or device input by the control unit 115, such as a keyboard, a touch screen display, a microphone, etc. Additionally, the one or more network interfaces 158 may facilitate connection of the control unit 115 to any number of suitable networks, such as the local area networks 140 and/or the external networks 145. In this regard, the control unit 115 may communicate with any number of other components of the system 100. For example, the control unit 115 may receive data from sensors 120, 125, 130, 135 and/or user devices 150. As another example, the control unit 115 may communicate commands to the various sensors 120, 125, 130, 135. As yet another example, the control unit 115 may communicate data to and/or receive data from the central server 110.

With continued reference to FIG. 1, the central server 110 may be a suitable processor-driven device configured to receive data from any number of local control units 115 (and/or sensors) and/or to determine a wide variety of actions based upon an evaluation of the received data. For example, in certain embodiments, the central server 110 may evaluate wave sensor data in order to determine location and/or movement of a monitored subject. As another example, the central server 110 may receive alert and/or other event information, and the central server 110 may process the received alert information. For example, the central server 110 may direct monitoring personnel to view a camera feed of the monitored area in order to determine whether authorities should be contacted. Examples of suitable processor-driven devices that may be utilized for the central server may include any number of suitable server computers, personal computers, minicomputers, microcontrollers, and/or other processor-based devices. In certain embodiments, the central server 110 may execute computer-executable instructions that form a special purpose computer or particular machine that facilitates the determination of whether an associated monitoring system has detected an event that should trigger an alert or implement one or more other control actions (e.g., activation or initiation of cameras and/or other sensors, etc. Although the central server 110 is described in greater detail below, at least a portion of the operations of the central server 110 described below and/or at least a portion of the operations described with reference to FIGS. 2 and 4-6 may be performed by the monitoring system control unit 115.

In addition to having one or more processors 172, the central server 110 may include any one or more suitable memory devices 174, one or more suitable input/output (“I/O”) interfaces 176, and/or one or more suitable network interfaces 178. The memory devices 174 may include any suitable memory devices, such as read-only memory devices, random access memory devices, magnetic storage devices, etc. The memory devices 174 may be configured to store a wide variety of data utilized by the central server 110, for example, data files 180, one or more customer profile databases 182, one or more event data databases 184, and/or any number of other databases and/or other logical memory constructs. Additionally, the memory devices 174 may be configured to store various software modules and/or executable instructions that may be executed by the one or more processors 172, such as a monitoring application 188.

The data files 180 may include any suitable data that facilitates the general operation of a central server 110, and/or a determination of the response of the monitoring system to various sensor states (e.g. determining and/or processing various locations and/or movements, processing received alert and/or event data, etc.). For example, the data files 180 may include various settings information associated with any number of household monitoring systems. As another example, the data files 180 may include contact information and/or network data associated with the household monitoring systems and/or individual sensors. As other examples, the data files 180 may include received measurements data (e.g., data collected by the sensors 120, 125, 130, 135) and/or received data associated with determined locations and/or tracked movements (i.e., location changes). A customer profile database 182 may include, for example, various application rules, preferences, and/or user profiles associated with one or more customers and/or profile information associated with desired control actions to take based upon identified alerts. The event data database 184 may include, for example, data associated with identified events, (e.g., identified alert events, change in area events, etc.) and/or information associated with received alert events. A wide variety of different files and/or logical memory constructs may be utilized to store data that is utilized in various embodiments of the invention. The various files and databases that are described above are provided by way of example only and should not be construed as limiting.

The operating system (“OS”) 186 may be a suitable software module that facilitates the general operation of the central server 110. Additionally, the OS 186 may facilitate the execution of any number of other software modules and/or applications, such as the monitoring application 188. The monitoring application 188 may be a suitable software module that receives various inputs and/or alerts from sensors, user devices, etc., and executes one or more action(s) based upon processing the received information. For example, the monitoring application 188 may identify alarm events and trigger an alarm and/or other control actions (e.g., escalation of an alarm, contacting a customer, etc.) in association with the identification of an alarm event. As another example, in certain embodiments, the monitoring application 188 may determine location and/or movement information associated with a monitored subject, and the monitoring application 188 may determine whether one or more control actions should be taken. Indeed, in certain embodiments, operations performed by the monitoring application 188 may be similar to those described above for the monitoring application 164 of the control unit 115. However, as desired, other operations may be performed. For example, the monitoring application 188 may direct monitoring personnel to review a camera feed or to attempt to establish contact with a user or customer once an alert event has been identified.

A few examples of the operations that may be performed by the monitoring application 188 are described in greater detail below with reference to FIGS. 2 and 4-6.

With continued reference to the central server 110, one or more input/output (“I/O”) interfaces 176 may facilitate interaction with any number of I/O devices that facilitate the receipt of user and/or device input by the central server 110, such as a keyboard, a mouse, a touch screen display, a microphone, etc. Additionally, the one or more network interfaces 178 may facilitate connection of the central server 110 to any number of suitable networks, such as a cellular network, a public-switched telephone network, the Internet, etc., that facilitate communication between the central server 110 and one or more other components of the system 100, such as the monitoring system control unit 115 and/or any number of user devices 150, such as a mobile device of a user. In this regard, the central server 110 may receive monitoring and/or measurements data from the control unit 115. Additionally, as desired, the central server 110 may receive user commands and/or requests for data from the control unit 115 and/or the user devices 150.

With continued reference to FIG. 1, any number of user devices 150 may be provided. One example of a suitable user device 150 is a mobile device (e.g., a mobile telephone, a personal digital assistant, etc.), although other types of user devices may be utilized, such as tablet computers, digital readers, etc. In certain embodiments, the user devices 150 may be recognized by and/or be in communication with the control unit 115, any number of sensors associated with a household monitoring system, and/or the central server 110. In this regard, user presence may be inferred by the presence or absence of user devices. Additionally, in certain embodiments, a user may utilize a user device 150 to provide commands to and/or receive data from one or more other components of the system 100. For example, a user device 150 may be configured to receive alarm data and/or event data from the control unit 115 and/or the central server 110, and at least a portion of the received data may be presented to a user. As another example, a user may utilize a user device 150 to provide any number of commands associated with the monitoring system to the control unit 115 and/or the central server 110, such as a request to escalate an alert or an indication that an alert is associated with a false alarm.

As desired in certain embodiments of the invention, a monitoring system 100 may include any number of sensors and/or cameras 125 that may function in a peer-to-peer mode on a local network or as a combination of peer-to-peer devices. Any number of the peer devices may have slave devices. For example, if a presence sensor (e.g., a motion detector, etc.) is triggered that would indicate the presence of subject, then one or more wave sensors 135 may be activated in order to determine a location and/or to track movement associated with the subject. As desired, based upon an evaluation of the wave sensor measurements data, a determination may be made that the subject is situated within the viewing area of one or more cameras 125 on a network, and the one or more cameras may be activated based upon the determination. In this regard, the recording and/or the network transmission of a video feed (e.g., the transmission of a video feed to a user device 150 or a central server 110, etc.) may be facilitated.

In various embodiments, it may be desirable for one or more cameras 125 to operate in a “keep alive” mode or a “sleep mode” until it is triggered by a slave sensor or another camera operating in a peer-to-peer mode on a local network. A camera 125 operating in a keep alive mode may be desirable to allow the camera 125 to operate on a battery and to preserve battery life. As desired in various embodiments, different cameras 125 may be activated and/or woken up as a monitored subject moves through a structure. For example, data collected by one or more wave sensors 135 may be evaluated in order to track the movement of a subject through a structure, and cameras 125 may be selectively activated based upon the movement.

In certain embodiments, a camera 125 may be a moveable or pan/tilt camera. One or more wave sensors 135 may be attached to, integrated into, and/or otherwise associated with the camera 125 and/or the pan/tilt mechanism on the camera 125. In this regard, the camera 125 may be programmed to follow a moving subject and/or scan an area based upon an evaluation of measurements data received from the wave sensors 135. For example, a camera 125 may be programmed to move in order to scan an area in which a monitored subject is determined to be located based upon an evaluation of wave sensor data. As another example, the camera 125 may be programmed to scan an area believed to be the last determined location for a subject that is no longer moving.

As desired, embodiments of the invention may include a system 100 with more or less than the components illustrated in FIG. 1. The system 100 of FIG. 1 is provided by way of example only.

FIG. 2 is a schematic block diagram of an example system 200 that may be utilized to track movement of one or more monitored subjects, according to an illustrative embodiment of the invention. With reference to FIG. 2, a camera 200 and/or any number of associated wave sensors 205 may be provided. In certain embodiments, the wave sensors 205 may be integrated into the camera 200 or incorporated into a housing of the camera 200. In other embodiments, the wave sensors 205 may be positioned in proximity to the camera 200 and in communication with processing components associated with the camera 200 (e.g., processing components of a smart camera, processing components of a local or external monitoring system in communication with the camera, etc.). In yet other embodiments, the wave sensors 205 may be positioned remotely from the camera 200. For purposes of describing FIG. 2, it will be assumed that processing of wave sensor measurements data may be performed by processing components associated with the camera 200.

With reference to FIG. 2, the wave sensors 205 may be configured to emit sound waves and detect reflections of the waves as the waves are reflected off of various objects or subjects, such as illustrated objects 210, 215, and 220. In certain embodiments, a wave sensor 205 may measure the time it takes for a wave reflection to be detected after a wave is emitted. In this regard, the wave sensor 205 may determine a distance to an object. Additionally, in certain embodiments, a distance or time to a known object, such as a door or wall, may be utilized in order to identify an object between the wave sensor and the known object. For example, if a reflection is detected in a time that is less than the reflection time for a wave to return from a known object or surface, then an object (e.g, a monitored subject) may be identified.

According to an aspect of the invention, the wave sensors 205 may also be utilized to detect and/or track movement and/or direction of a monitored object. With reference to FIG. 2, the camera 200 may receive output data from the wave sensors 205, and the camera may process the output data to determine a direction of movement for an object. Alternatively, wave sensor output data may be processed by a local processing unit, and the local processing unit may direct operations of the camera 200. A reflection time associated with the sensor output may be sampled periodically, for example, every second. When an object, such as illustrated object 210, is moving toward the wave sensors 205, the reflection time may be determined to be decreasing between samples. Alternatively, when an object, such as illustrated object 215, is moving away from the wave sensors 205, then the reflection time may be determined to be increasing between samples. As another example, when an object, such as illustrated object 220, is moving across a wave beam, then reflection time remains constant.

As desired, multiple wave sensors may be utilized in conjunction with one another to track movement of an object. For example, a grid of wave sensors may be provided. As one example, respective wave sensors may be placed on different walls within a monitored area. As another example, a phased array of wave sensors may be provided. As a result of providing multiple wave sensors, the motion of an object may be tracked in a wide variety of different directions. For example, if the object is moving across the wave beam of a first wave sensor, then data from a second wave sensor may be utilized to pinpoint a location and detect movement of the object.

Additionally, as desired in various embodiments, the direction of movement for an object may be used to activate another camera or sensor on a peer-to-peer network or may be used as input by the monitoring system control unit 115 or central server 110 to initiate any number of other suitable control actions (e.g., triggering an alarm, turning lights on or off, etc.).

FIGS. 3A and 3B illustrate example camera configurations that may be utilized in various embodiments of the invention. With reference to FIG. 3A, a camera 300 may be mounted to a wall or other surface, and one or more wave sensors 305 may be separately mounted to the wall or other surface. As desired, the wave sensors 305 may be mounted in relatively close proximity to the camera 300. Additionally or alternatively, one or more wave sensors 305 may be mounted in a relatively remote configuration. For example, one or more wave sensors 305 may be mounted on other walls or surfaces. In operation, measurements data collected by the wave sensors 305 may be evaluated and, as desired, utilized to control the operation of the camera 300. For example, measurements data may be utilized to detect a location and/or to track movement of a monitored subject. The camera 300 may then be activated or initiated. Additionally, as desired, a pan, tilt, and/or other motion of the camera 300 may be control led.

With reference to FIG. 3B, another example camera 310 is illustrated. The camera 310 illustrated in FIG. 3B may include one or more wave sensors 315 integrated into the camera 310. For example, one or more wave sensors 315 may be incorporated into a housing of the camera 310. In operation, measurements data collected by the wave sensors 315 may be evaluated (e.g., evaluated by the camera 310 or another processing device) and, as desired, utilized to control the operation of the camera 310. For example, measurements data may be utilized to detect a location and/or to track movement of a monitored object. The camera 310 may then be activated or initiated. Additionally, as desired, a pan, tilt, and/or other motion of the camera 310 may be controlled.

The example camera configurations illustrated in FIGS. 3A and 3B are provided by way of example only. Other configurations may be utilized as desired in various embodiments of the invention.

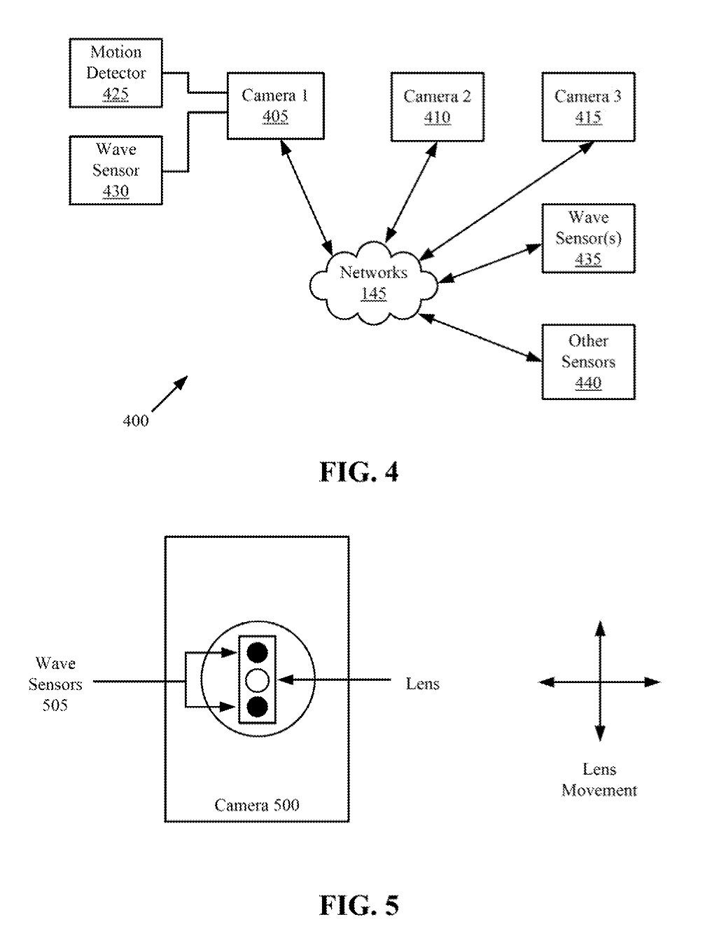

FIG. 4 is a block diagram of an example monitoring system 400 that may be utilized to track the movement of a monitored subject, according to an illustrative embodiment of the invention. With reference to FIG. 4, a plurality of cameras 405, 410, 415 are illustrated. As desired, each of the cameras 405, 410, 415 may be in communication with one or more other cameras via a local area network 420. For example, the cameras 405, 410, 415 may be configured to operate in a peer-to-peer mode.

Camera 405 is illustrated as including or being associated with any number of slave motion detectors 425 and/or wave sensors 430. Additionally, as desired, any number of other wave sensors 435 and/or other sensors 440 may be provided. In certain embodiments, at least a portion of the other wave sensors 435 and/or other sensors 440 may operate in a peer-to-peer mode with one or more of the cameras 405, 410, 415. Indeed, a wide variety of monitoring system configurations may be utilized as desired.

In operation, one or more sensors, such as the motion detector 425, may identify the presence of a subject or object to be monitored. Based upon the identification of the subject, any number of wave sensors 430, 435 may be activated and utilized to track the location and/or movement of the subject. Additionally, based at least in part upon the tracked location and/or movement, one or more of the cameras 405, 410, 415 may be activated and/or awakened. For example, as the subject enters a viewable area of a camera, the camera may be activated. As another example, as the subject exits the viewable area of a camera, the camera may be deactivated or placed in a sleep mode.

As one example use, data collected by the motion detector 425 and wave sensor 430 may be evaluated in order to determine that a subject is moving towards a camera, such as slave camera 410. A primary camera 405 may then send a “wake up” call or activation message to the slave camera 410 towards which the subject is moving. In this regard, various slave cameras may be activated as needed and utilized to monitor a subject that is being tracked. As desired, the various cameras 405, 410, 415 may facilitate the recording of monitoring data and/or the communication of a video feed to any number of other devices.

As desired, embodiments of the invention may include a system 400 with more or less than the components illustrated in FIG. 4. The system 400 of FIG. 4 is provided by way of example only.

FIG. 5 is a block diagram of another example camera 500 that may be utilized in various embodiments of the invention. With reference to FIG. 5, a camera 500 is illustrated in which one or more suitable wave sensors 505 are integrated into a pan/tilt mechanism of the camera. As desired, the camera 500 may operate in a patrol mode to detect changes in a monitored environment. In certain embodiments, the camera 500 may receive wave sensor data associated with a detected subject or object, and the camera 500 may utilize at least a portion of the received data to track the detected subject. For example, a grid of wave sensors may be utilized to track the position of an intruder within a structure, and the camera 500 may be utilized to track the intruder.

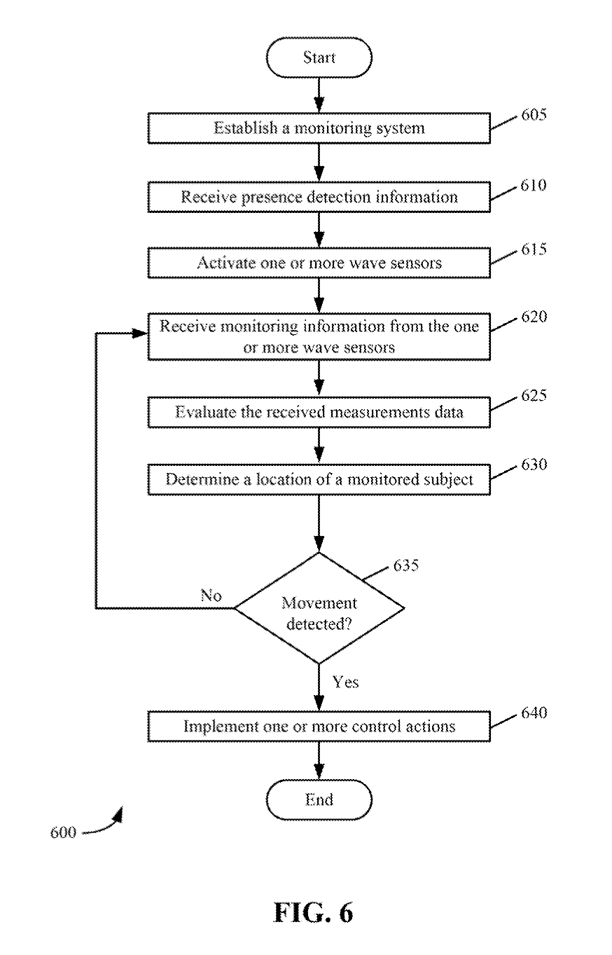

FIG. 6 is a flow diagram of an example method 600 for detecting presence, location, and/or movement of a monitored subject, according to an illustrative embodiment of the invention. Various operations of the method 600 may be performed by a monitoring system control unit and/or by a central server, such as the control unit 115 and/or the central server 110 illustrated in FIG. 1. For example, various operations of the method 600 may be performed by a suitable monitoring application associated with the control unit 115 and/or by a suitable monitoring application associated with the central server 110, such as one or both of the monitoring applications 164, 188 illustrated in FIG. 1. The method may begin at block 605.

At block 605, a monitoring system may be installed, established, and/or initiated. As desired, the monitoring system may be configured to conduct a wide variety of different types of monitoring, such as security monitoring and/or energy management monitoring. According to an aspect of the invention, the monitoring system may include any number of suitable wave sensors, such as ultrasonic sensors. The wave sensors may be positioned in a wide variety of suitable configurations (e.g., a plurality of wave sensors positioned on various walls or surfaces, a group of wave sensors placed in a corner of a room, wave sensors incorporated into one or more cameras, a phased array of wave sensors, etc.) in order to cover a desired monitoring area. In this regard, the wave sensors may monitor one or more subjects positioned within the monitoring area to facilitate a determination of location and/or movement of the subjects.

As desired in various embodiments, a wide variety of profile data may be obtained. In certain embodiments, profile information associated with one or more relatively stationary objects situated within a monitored area may be obtained. For example, dimensional information associated with furniture and/or other objects positioned within a monitored room may be obtained. As desired, profile data may be obtained utilizing a wide variety of suitable techniques. For example, a user of the monitoring system may utilize one or more suitable input devices to provide profile data to the monitoring system. As another example, profile information may be entered via any number of suitable Web pages and/or graphical user interfaces hosted by a suitable server (e.g., a Web server, etc.) associated with the monitoring system. As yet another example, the monitoring system may be placed in a configuration and/or learning mode. While in the learning mode, the one or more wave sensors may take one or more measurements utilized to generate steady-state or baseline information (e.g., dimensions, etc.) associated with the monitored area and/or one or more subjects to be monitored.

At block 610, the monitoring system may be activated. Additionally, the presence of a subject to be monitored may be detected. As desired, presence may be detected by any number of suitable detection devices associated with a monitored area of interest. For example, one or more suitable motion detectors may be utilized to detect the presence of an individual entering a monitored area and/or located within the monitored area. A motion detector may be, for example, a traditional body heat sensor, a door contact, etc. As desired, the monitoring system (e.g., a control unit 115, etc.) may receive measurements data and/or a presence detection indication from the detection devices. In this regard, the monitoring system may determine that a subject to be monitored is located within an area of interest. Based at least in part upon the detected presence of a subject to be monitored, one or more suitable wave sensors associated with the area, such as the wave sensors 135 illustrated in FIG. 1, may be activated at block 615. For example, a control unit 115 may send one or more suitable signals to the wave sensors 135 in order to awaken and/or activate the wave sensors 135.

At block 620, the wave sensors 135 may output sound waves and receive reflection data associated with the output waves. The wave sensors 135 may then communicate the reflection distance data and/or timing data associated with the detected reflections to the control unit 115. The control unit 115, either alone or in conjunction with a central server 110, may receive the measurements data. The received measurements data may be processed and/or evaluated at block 625 utilizing a wide variety of suitable evaluation techniques. For example, the measurements data may be compared to baseline data and/or expected data, such as data stored in a suitable profile. In this regard, deviations from the baseline data may be determined. As one example, the measurements data may be compared to baseline data associated with stationary objects in the monitored area. Differences between the monitored data and the baseline data may then be identified.

At block 630, a location of a monitored subject may be determined. For example, differences between baseline data (or expected data) and monitored data may be identified in order to determine a position or location of a monitored subject. As desired, profile information associated with one or more relatively stable objects (e.g., furniture) may be taken into consideration when determining a location and/or movement of a monitored subject. For example, in certain embodiments, the profile information may be utilized to establish the baseline data.

At block 635, the location of the monitored subject may be periodically or continually monitored while the subject is located within the monitored area. For example, the control unit 115 and/or central server 110 may monitor measurements data in an attempt to identify changes in location or movement within the monitored area. As one example, wave sensor data may be periodically received, analyzed, and/or compared to previous data in order to identify changes in movement and/or position. Additionally, at block 635, a determination may be made as to whether a location of the monitored subject has changed. If it is determined at block 635 that a location has not changed, then operations may continue at block 620, and monitoring may continue. If, however, it is determined at block 635 that a location has changed (i.e., movement is detected), then operations may continue at block 640.

Although block 635 described the detection of movement or changes in location, in certain embodiments, measurements data may be evaluated in order to determine when a moving subject has stopped. As desired, any number of suitable control actions may be taken based upon the determination that the subject has stopped.

At block 640, one or more suitable control actions may be implemented as directed based at least in part upon the determination that a monitored subject has moved or that a location has changed. As one example, the monitoring system may determine that a monitored subject is moving into the viewing area of a camera, and the monitoring system may activate the camera. As another example, the monitoring system may adjust the pan and/or tilt of a camera based upon the movement and/or location of a monitored subject. As yet another example, the monitoring system may determine that a monitored subject is entering or exiting a room, and the monitoring system may implement a wide variety of actions based upon the determination. For example, the monitoring system may identify a security alert, and the monitoring system may generate a suitable alarm action (e.g., triggering an audible alarm, communicating a message to a user or central control system, activating one or more sensors or monitoring devices, contacting authorities, etc.). As another example, the monitoring system may turn off the lights (or air conditioning or heating) in a room being exited and/or turn on the lights (or air conditioning or heating) in room being entered. A wide variety of other control actions may be taken as desired in various embodiments of the invention.

The method 600 may end following block 640.

The operations described in the method 600 of FIG. 6 do not necessarily have to be performed in the order set forth in FIG. 6, but instead may be performed in any suitable order. Additionally, in certain embodiments of the invention, more or less than all of the elements or operations set forth in FIG. 6 may be performed.

The invention is described above with reference to block and flow diagrams of systems, methods, apparatuses, and/or computer program products according to example embodiments of the invention. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention.

These computer-executable program instructions may be loaded onto a general purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special purpose hardware and computer instructions.

While the invention has been described in connection with what is presently considered to be the most practical and various embodiments, it is to be understood that the invention is not to be limited to the disclosed embodiments, but on the contrary, is intended to cover various modifications and equivalent arrangements included within the scope of the appended claims.

This written description uses examples to disclose the invention, including the best mode, and also to enable any person skilled in the art to practice the invention, including making and using any devices or systems and performing any incorporated methods. The patentable scope of the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A monitoring system comprising:
at least one wave sensor configured to emit sound waves and detect reflections of the emitted sound waves; and
at least one processor configured to:
receive measurements data from the at least one wave sensor;
identify, based at least in part upon the received measurements data, a location of a subject to be monitored; and
track, based at least in part upon the received measurements data, movement of the subject.

2. The monitoring system of claim 1, wherein the at least processor is further configured to initiate, based at least in part upon the identification, at least one camera.

3. The monitoring system of claim 2, wherein the at least one processor is further configured to:
determine, based at least in part upon the tracking, that the subject is moving within a viewing area of the at least one camera; and
initiate the at least one camera based at least in part upon the determination that the subject is moving within the viewing area.

4. The monitoring system of claim 2, wherein the at least one processor is integrated into a primary camera, and wherein the at least one initiated camera comprises a slave camera.

5. The monitoring system of claim 1, wherein the at least one wave sensor comprises an ultrasonic wave sensor.

6. The monitoring system of claim 1, wherein the at least one wave sensor comprises a plurality of wave sensors, and
wherein the at least one processor is further configured to:
track the movement of the subject based at least in part upon measurements data received from the plurality of wave sensors; and
direct, based at least in part upon the tracking, movement of at least one camera.

7. The monitoring system of claim 1, wherein the at least one wave sensor comprises one of (i) a plurality of wave sensors arranged in a grid or (ii) a phased array of wave sensors.

8. The monitoring system of claim 1, wherein the at least one processor is further configured to:
determine, based at least in part upon the tracking, that an alarm threshold is satisfied; and
implement, based upon the determination that the alarm threshold is satisfied, at least one control action.

9. The monitoring system of claim 1, further comprising:
at least one sensor configured to detect presence of the monitored subject,
wherein the at least one wave sensor is activated based at least in part upon the detected presence.

10. A method comprising:
receiving, by a monitoring system comprising one or more computer processors, measurements data collected by at least one wave sensor configured to emit sound waves and detect reflections of the emitted sound waves;
identifying, by the monitoring system based at least in part upon the received measurements data, a location of a subject to be monitored; and
tracking, by the monitoring system based at least in part upon the received measurements data, movement of the subject.

11. The method of claim 10, further comprising:
initiating, by the monitoring system based at least in part upon the identification, at least one camera.

12. The method of claim 11, further comprising:
determining, by the monitoring system based at least in part upon the tracking, that the subject is moving within a viewing area of the at least one camera;
wherein initiating the at least one camera comprises initiating the at least one camera based at least in part upon the determination that the subject is moving within the viewing area.

13. The method of claim 11, wherein initiating at least one camera comprises initiating a slave camera by a primary camera.

14. The method of claim 10, wherein receiving measurements data collected by at least one wave sensor comprises receiving measurements data collected by an ultrasonic wave sensor.

15. The method of claim 10, wherein receiving measurements data collected by at least one wave sensor comprises receiving measurements data collected by a plurality of wave sensors, and further comprising:
tracking, by the monitoring system based at least in part upon the received measurements data, movement of the subject; and
directing, by the monitoring system based at least in part upon the tracking, movement of at least one camera.

16. The method of claim 10, wherein receiving measurements data collected by at least one wave sensor comprises receiving measurements data from at least one of (i) a plurality of wave sensors arranged in a grid or (ii) a phased array of wave sensors.

17. The method of claim 10, further comprising:
determining, by the monitoring system based at least in part upon the tracking, that an alarm threshold is satisfied; and
implementing, by the monitoring system based upon the determination that the alarm threshold is satisfied, at least one control action.

18. The method of claim 10, further comprising:
receiving, by the monitoring system from at least one sensor, presence detection information associated with the monitored subject; and
activating, by the monitoring system based at least in part upon the presence detection data, the at least one wave sensor.

19. A method, comprising:
receiving, by a security camera comprising one or more processing components from one or more wave sensors, measurements data collected by one or more wave sensors;
evaluating, by the security camera, the received measurements data to determine a location of a monitored subject; and
determining, by the security camera based at least in part upon the measurements data, a change in location of the monitored subject.

20. The method of claim 19, further comprising:
initiating by the security camera based at least in part upon the determined change in location, at least one additional security camera.
